(19) United States
(12) Patent Application Publication
(10) Pub. No.: US 2023/0335107 A1
(43) Pub. Date: Oct. 19, 2023

(54) Reference-Free Foreign Accent Conversion System and Method

(71) Applicant: The Texas A&M University System, College Station, TX (US)

(72) Inventors: Guanlong Zhao, College Station, TX (US); Shaojin Ding, College Station, TX (US); Ricardo Gutierrez-Osuna, College Station, TX (US)

(73) Assignee: The Texas A&M University, College Station, TX (US)

(21) Appl. No.: 18/023,219

(22) PCT Filed: Aug. 24, 2021
(86) PCT No.: PCT/US2021/047365

§ 371 Date: Feb. 24, 2023

Related U.S. Application Data
(60) Provisional application No. 63/069,306, filed on Aug. 24, 2020.

(51) Int. Cl. G10L 13/027; G10L 15/06; G10L 15/16; G10L 15/02; G10L 15/00

(52) U.S. Cl. CPC G10L 13/027; G10L 15/063; G10L 15/16; G10L 15/02; G10L 15/005; G10L 2015/025

(57) ABSTRACT

Provided herein is a reference-free foreign accent conversion (FAC) computer system and methods for training models, utilizing a library of algorithms, to directly transform utterances from a foreign, non-native speaker (L2) or second language (L2) speaker to have the accent of a native (L1) speaker. The models in the reference-free FAC computer system are a speech-independent acoustic model to extract speaker independent speech embeddings from an L1 speaker utterance and/or the L2 speaker, a speech synthesizer to generate L1 speaker reference-based golden-speaker utterances and a pronunciation correction model to generate a L2 speaker reference-free golden speaker utterances.

### CROSS-REFERENCE TO RELATED APPLICATIONS

This international application claims benefit of priority under 35 U.S.C. § 119(e) of pending provisional application U.S. Ser. No. 63/069,306, filed Aug. 24, 2020, the entirety of which is hereby incorporated by reference.

### FEDERAL FUNDING LEGEND

This invention was made with government support under Grant Numbers 1619212 and 1623750 awarded by the National Science Foundation. The government has certain rights in the invention.

### BACKGROUND OF THE INVENTION

### Field of the Invention

The present invention is in the fields of generic speech modification techniques and voice synthesis. More specifically, the present invention is directed to systems, models and processes for foreign, non-native or second language henceforth L2 for all, accent conversion, that directly transforms an L2 speaker's utterances to make them sound more native-like, without the need of reference utterances from a native, henceforth L1, speaker at synthesis time.

### Description of the Related Art

Foreign accent conversion (FAC) (1) aims to create a synthetic voice that has the voice identity (or timbre) of an L2 speaker but the pronunciation patterns (or accent) of an L1 speaker. In the context of computer-assisted pronunciation training (1-4), this synthetic voice is often referred to as a “golden speaker” for the L2 speaker or a second-language (L2) learner. The rationale is that the golden speaker is a better target for the L2 learner to imitate than an arbitrary native speaker, because the only difference between the golden speaker and the L2 learner's own voice is the accent, which makes mispronunciations more salient. In addition to pronunciation training, FAC finds applications in movie dubbing (5), personalized Text-To-Speech (TTS) synthesis (6, 7), and improving automatic speech recognition (ASR) performance (8).

The main challenge in FAC is that one does not have ground-truth data for the desired golden speaker, since, in general, the L2 learner is unable to produce speech with a native accent. Therefore, it is not feasible to apply conventional voice-conversion (VC) techniques to the FAC problem. Previous solutions work around this issue by requiring a reference utterance from an native L1 speaker at synthesis time. But this limits the types of pronunciation practice that FAC techniques can provide, e.g., the L2 learner can only practice sentences that have already been prerecorded by the reference L1 speaker.

Zhao et al. (27) used sequence-to-sequence (seq2seq) models to perform FAC in which a seq2seq speech synthesizer is trained to convert phonetic posteriograms (PPGs) to Mel-spectra using recordings from the L2 speaker. Then, golden-speaker utterances were generated by driving the seq2seq synthesizer with PPGs extracted from an L1 utterance, a process that reminisces articulatory-based methods, that is, if PPGs are viewed as articulatory information. This produced speech that was significantly less accented than the original L2 speech. Miyoshi et al. (34) built a seq2seq model that mapped source context posterior probabilities to the target's; they obtained better speech individuality ratings, but worse audio quality, than a baseline without the context posterior mapping process.

Zhang et al. (35) concatenated bottleneck features and Mel-spectrograms from a source speaker, used a seq2seq model to convert the concatenated source features into the target Mel-spectrogram, and finally recovered the speech waveform with a WaveNet (36) vocoder (37). Zhang et al. then applied text supervision (12) to resolve some of the mispronunciations and artifacts in the converted speech. More recently, they extended their framework to the non-parallel condition (38) with trainable linguistic and speaker embeddings. Other notable seq2seq VC works include (39), which proposed a novel loss term that enforced attention weight diagonality to stabilize the seq2seq training; the Parrotron (8) system, which uses large-scale corpora and seq2seq models to normalize arbitrary speaker voices to a synthetic TTS voice; and (40), which used a fully convolutional seq2seq model instead of conventional recurrent neural networks (RNNs, e.g., LSTM) because RNNs are costly to train and difficult to optimize for parallel computing.

Liu et al. proposed a reference-free FAC system (41) that used a speaker encoder, a multi-speaker TTS model, and an ASR encoder. The speaker encoder and the TTS model are trained with L1 speech only, and the ASR encoder is trained on speech data from L1 speakers and the target L2 speaker. During testing, they use the speaker encoder and ASR encoder to extract speaker embeddings and linguistic representations from the input L2 testing utterance, respectively. Then, they concatenate the two and feed them to the multi-speaker TTS model, which then generates the accent-converted utterance. Their evaluations suggested that the converted speech had a near-native accent, but did not capture the voice identity of the target L2 speaker because it had to be interpolated by their multi-speaker TTS.

There is a deficiency in the art for FAC systems, in that they require utterances from a reference speaker at synthesis time. Particularly, there is a deficiency in the art for FAC systems that can directly transform utterances of an L2 speaker of a language to have the accent of an L1 speaker of the language. The present invention fulfills this longstanding need and desire in the art.

### SUMMARY OF THE INVENTION

The present invention is directed to a foreign accent conversion (FAC) system. In a computer system with at least one processor, at least one memory in communication with the processor and at least one network connection a plurality of models in communication with a plurality of algorithms configured to train the plurality of models to transform directly utterances of a non-native (L2) speaker to match an utterance of a native (L1) counterpart. The plurality of models and the plurality of algorithms are algorithms are tangibly stored in at least one memory and in communication with the processor.

The present invention also is directed to a reference-free foreign accent conversion (FAC) computer system. The reference-free FAC computer system comprises at least one processor, at least one memory in communication with the processor, and at least one network connection. A plurality of trainable models in communication with the processor is configured to convert input utterances from a non-native (L2) speaker to native-like sounding output utterances of the one or more languages. A software toolkit comprises a library of algorithms tangibly stored in at least one memory and in communication with at least one processor and with the plurality of models which when said algorithms are executed by the processor train the plurality of models to convert the input L2 utterances.

The present invention is directed further to a computer-implemented method for training a system for foreign accent conversion. In the method an input set of input utterances is collected from a reference native (L1) speaker and from a non-native (L2) learner. A foreign accent conversion model is trained to transform the input utterances from the L1 speaker to have a voice identity of the L2 learner to generate L1 golden speaker utterances (L1-GS). A pronunciation-correction model is then trained to transform utterances from the L2 learner to match the L1 golden speaker utterances (L1-GS) as output.

The present invention is directed to a related computer-implemented method further comprising discarding the input utterances (L1) after generating the native golden speaker utterances (L1-GS). The present invention is directed to another related computer-implemented method further comprising training the pronunciation-correction model to transform new L2 utterances (New L2) as input to new accent-free L2 learner golden speaker utterances (New L2-GS).

The present invention is directed further still to a method for transforming foreign utterances from a non-native (L2) speaker to native-like sounding utterances of a native L1 speaker. In the method a set of parallel utterances is collected from the L2 speaker and from the L1 speaker and a speech synthesizer is built for the L2 speaker. The speech synthesizer is driven with a set of utterances from the L1 speaker to produce a set of golden-speaker utterances which synthesizes the L2 voice identity with the L1 speaker pronunciation patterns and the set of utterances from the L1 speaker is discarded. A pronunciation-correction model configured to directly transform the utterances from the L2 speaker to match the set of golden-speaker utterances is built.

Other and further aspects, features, benefits, and advantages of the present invention will be apparent from the following description of the presently preferred embodiments of the invention given for the purpose of disclosure.

### BRIEF DESCRIPTION OF THE DRAWINGS

So that the matter in which the above-recited features, advantages and objects of the invention, as well as others that will become clear, are attained and can be understood in detail, more particular descriptions of the invention briefly summarized above may be had by reference to certain embodiments thereof that are illustrated in the appended drawings. These drawings form a part of the specification. It is to be noted, however, that the appended drawings illustrate preferred embodiments of the invention and therefore are not to be considered limiting in their scope.

FIG. 1 is a schematic of the overall workflow of the proposed system. L1: native; L2: non-native; GS: golden speaker; SI: speaker independent.

FIG. 2 is a monophone-PPG of the spoken word balloon, whose pronunciation is “B AH L UW N” in the ARPAbet phoneme set. “SIL” means silence. The colorbar shows the probability values from zero to one. For visualization purposes, rows (monophones) with low values were omitted and also aggregated the probability mass of all monophones that only differ in stressing and word positions, e.g., the probability mass of AH{∅, 0, 1, 2}_{initial, mid, final} is added into a single entry AH) were aggregated. An American English speaker uttered this word.

FIG. 3 illustrates speech embedding to a Mel-spectrogram synthesizer. The speech embeddings are sequentially processed by an input PreNet (optional, for Senone-PPGs only), convolutional layers, an encoder, a decoder, and a PostNet to generate their corresponding Mel-spectra. For better visualization the stop token predictions are omitted.

FIG. 4 illustrates the training pipeline of the baseline pronunciation-correction model. The decoder has the same neural network structure as the one in Error! Reference source not found.

FIG. 5 is a proposed forward-and-backward decoding model for pronunciation-correction which is only activated during training. The existing decoder in the baseline model is denoted as the forward decoder here. The other common components it shares with the baseline model are omitted. The PostNet of the two decoders shares the same set of weights.

FIG. 6 is a qualitative comparison of the attention weights generated by the baseline and the proposed pronunciation-correction systems on one testing utterance.

FIG. 7 is a qualitative comparison of the attention weights generated by the forward and backward decoders of the proposed pronunciation-correction systems on three utterances from the validation set.

### DETAILED DESCRIPTION OF THE INVENTION

For convenience, before further description of the present invention, certain terms employed in the specification, examples and appended claims are collected herein. These definitions should be read in light of the remainder of the disclosure and understood as by a person of skill in the art. Unless defined otherwise, all technical and scientific terms used herein have the same meaning as commonly understood by a person of ordinary skill in the art.

The articles “a” and “an” when used in conjunction with the term “comprising” in the claims and/or the specification, may refer to “one”, but is also consistent with the meaning of “one or more”, “at least one”, and “one or more than one”. Some embodiments of the invention may consist of or consist essentially of one or more elements, components, method steps, and/or methods of the invention. It is contemplated that any composition, component or method described herein can be implemented with respect to any other composition, component or method described herein.

The term “or” in the claims refers to “and/or” unless explicitly indicated to refer to alternatives only or the alternatives are mutually exclusive, although the disclosure supports a definition that refers to only alternatives and “and/or”.

The terms “comprise” and “comprising” are used in the inclusive, open sense, meaning that additional elements may be included.

The term “including” is used herein to mean “including, but not limited to”. “Including” and “including but not limited to” are used interchangeably.

As used herein, the terms “foreign accent conversion system”, “reference-free foreign accent conversion computer system” and “foreign accent conversion computer system” are interchangeable.

As used herein, the terms “models” and “trainable models” are interchangeable.

As used herein, the terms “accent” and “pronunciation” are interchangeable. A foreign accent can be defined as the systematic deviation from the standard norm of a spoken language. The deviations can be observed at the segmental level, for example, substitution, deletion, or insertion of phones, and/or at the suprasegmental level such as prosody deviations, i.e., differences in intonation, tone stress, and rhythm.

As used herein, with respect to Tacotron2, the term “PreNet” refers to two fully connected layers with a ReLU nonlinearity, “PostNet” refers to five stacked 1-D convolutional layers and “LinearProjection” refers to one fully connected layer.

As used herein, the terms “L1 speaker” and “L1” refer to a native speaker.

As used herein, the terms “L2 speaker”, “L2 learner” and “L2” refer to a non-native speaker or a non-native learner.

In one embodiment of the present invention there is provided a foreign accent conversion system, comprising in a computer system with at least one processor, at least one memory in communication with the processor and at least one network connection a plurality of models in communication with a plurality of algorithms configured to train said plurality of models to transform directly utterances of a non-native (L2) speaker to match an utterance of a native (L1) golden-speaker counterpart, the plurality of models and the plurality of algorithms tangibly stored in the at least one memory and in communication with the processor.

In this embodiment the plurality of models may be trained to create the golden-speaker using a set of utterances from a reference L1 speaker, which are discarded thereafter, and the L2 speaker learning the at least one language; and convert the L2 speaker utterances to match the golden speaker utterances. Further to this embodiment the plurality of models are trained to convert new utterances from the L2 speaker to match a new golden speaker utterances. Also in these embodiments the plurality of algorithms may comprise a software toolkit.

In these embodiments the plurality of models may comprise at least a speaker independent acoustic model, an L2 speaker speech synthesizer and a pronunciation correction model. In one aspect of these embodiments the speaker independent acoustic model may be trained to extract speech embeddings from the set of utterances. In another aspect the L2 speaker speech synthesizer may be trained to re-create the L2 speech from the speaker independent embeddings. In yet another aspect the speaker independent acoustic model may be trained to transform L1 speech into L1 speaker independent embeddings which are passed through the L2 speaker speech synthesizer to generate the golden speaker utterances. In yet another aspect the pronunciation correction model may be trained to convert the L2 speaker utterances to match the golden speaker utterances.

In another embodiment of the present invention there is provided a reference-free foreign accent conversion computer system, comprising at least one processor; at least one memory in communication with the processor; at least one network connection; a plurality of trainable models in communication with the processor configured to convert input utterances from a non-native (L2) speaker learning one or more languages to native-like sounding output utterances of the one or more languages; and a software toolkit comprising a library of algorithms tangibly stored in the at least one memory and in communication with the at least one processor and with the plurality of models which when said algorithms are executed by the processor train the plurality of models to convert the input L2 utterances.

In this embodiment the plurality of models may comprise at least a speaker independent acoustic model, an L2 speaker speech synthesizer and a pronunciation correction model. In one aspect the speaker independent acoustic model may be configured to extract speaker independent speech embeddings from a native (L1) speaker input utterance, from the L2 speaker or from a combination thereof. In another aspect the L2 speaker speech synthesizer may be configured to generate L1 speaker reference-based golden-speaker utterances. In yet another aspect the pronunciation correction model may be configured to generate L2 speaker reference-free golden speaker utterances.

In yet another embodiment of the present invention there is provided a computer-implemented method for training a system for foreign accent conversion, comprising the steps of collecting an input set of input utterances from a reference native (L1) speaker and from a non-native (L2) learner; training a foreign accent conversion model to transform the input utterances from the L1 speaker to have a voice identity of the L2 learner to generate L1 golden speaker utterances (L1-GS); and training a pronunciation-correction model to transform utterances from the L2 learner to match the L1 golden speaker utterances (L1-GS) as output.

Further to this embodiment the method comprises discarding the L1 input utterances after generating the L1 golden speaker utterances (L1-GS). In another further embodiment the method comprises training the pronunciation-correction model to transform new L2 learner utterances (New L2) as input to new accent-free L2 learner golden speaker utterances (New L2-GS). In all embodiments the collecting step may comprise extracting speaker independent speech embeddings from the input set of input utterances.

In yet another embodiment of the present invention there is provided a method for transforming foreign utterances from a non-native (L2) speaker to native-like sounding utterances of a native (L1) speaker, comprising the steps of collecting a set of parallel utterances from the L2 speaker and from the L1 speaker; building a speech synthesizer for the L2 speaker; driving the speech synthesizer with a set of utterances from the L1 speaker to produce a set of golden-speaker utterances which synthesizes the L2 voice identity with the L1 speaker pronunciation patterns; discarding the set of utterances from the L1 speaker; and building a pronunciation-correction model configured to directly transform the utterances from the L2 speaker to match the set of golden-speaker utterances.

In this embodiment the speech synthesizer may comprise a speaker independent acoustic model configured to extract speaker independent speech embeddings from the parallel utterances. Also in this embodiment the pronunciation-correction model is further configured to directly transform new utterances from the L2 speaker to match a new set of golden speaker utterances.

Provided herein is a reference-free foreign accent conversion (FAC) computer system and methods for training the system to transform foreign utterances from an L2 speaker to sound more like those of an L1 speaker. Generally the computer system or other equivalent electronic system, as is known in the art, comprises at least one memory, at least one processor and at least one wired or wireless network connection. The reference-free FAC computer system comprises a software toolkit comprising a processor-executable library of algorithms and a plurality of models or modules trainable by the algorithms to effect the foreign accent conversion without using utterances from a reference L1 speaker during synthesis of the L2 speaker utterances and to keep the voice identity of the speaker un-altered. Therefore, no reference utterances from an L1 speaker are required for the software toolkit at runtime. The software toolkit and the library of algorithms are tangibly stored in the computer system or are available to the system via a network connection.

The plurality of trainable models comprises a speech-independent acoustic model to extract speaker independent speech embeddings from an L1 speaker input utterance and/or the L2 speaker, a speech synthesizer to generate an L1 speaker reference-based golden-speaker utterances; and a pronunciation correction model to generate an L2 speaker reference-free golden speaker utterances. The reference-free foreign accent conversion system also uses transfer learning to reduce the amount of training data needed for the golden-speaker generation process.

Particularly, the reference-free FAC system starts with a training set of parallel utterances from an L2 speaker or learner of a language and from a reference L1 speaker. The training pipeline in the reference-free FAC system is a two step process. In step one, an L2 speech synthesizer (9) is built that maps speech embeddings from L2 non-native speaker utterances into their corresponding Mel-spectrograms. The speech embeddings are extracted using an acoustic model trained on a large corpus of native speech, so they are speaker-independent (10, 11). The L2 synthesizer is then driven with speech embeddings extracted from the L1 utterances. This results in a set of golden-speaker utterances that have the voice identity of the L2 learner since they are generated from the L2 synthesizer and the pronunciation patterns of the L1 speaker since the input is obtained from an L1 utterance. The L1 utterances are discarded at this point. In the second and key step, a pronunciation-correction model is trained to convert the L2 utterances to match the golden-speaker utterances obtained in the first step, which serve as a target. During inference time, a new L2 utterance is fed to the pronunciation-correction model, which then generates its “accent free” counterpart.

The following examples are given for the purpose of illustrating various embodiments of the invention and are not meant to limit the present invention in any fashion.

### Example 1

### Methods

### Overall Steps to Reference-Free FAC

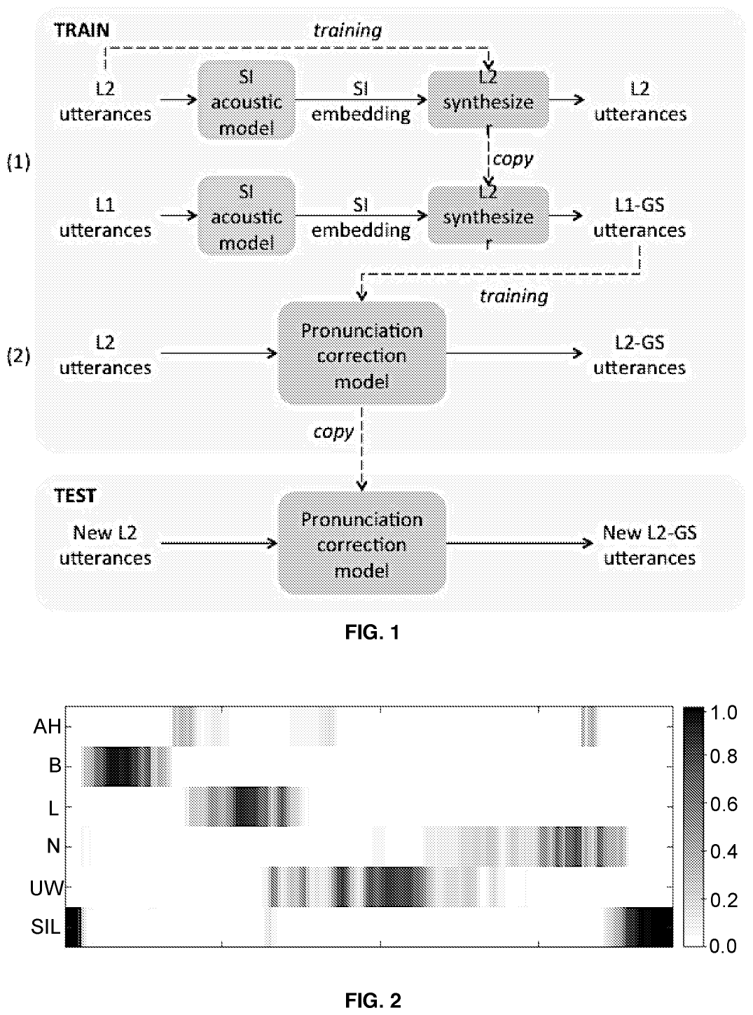

The proposed approach to reference-free FAC is illustrated in FIG. 1. The system requires a parallel corpus of utterances from the L2 speaker and a reference L1 speaker. The training process consists of two steps. In a first step, a speech synthesizer for the L2 speaker is built that converts speech embeddings into Mel-spectrograms. The L2 synthesizer is then driven with a set of utterances from the reference L1 speaker, to produce a set of golden-speaker utterances, i.e., L2 voice identity with L1 pronunciation patterns). These are referred to as L1 golden-speaker (L1-GS) utterances, since they are obtained using L1 utterances as a reference. The L1 utterances can be discarded at this point. In a second step, a pronunciation-correction model is built that directly transforms L2 utterances to match their corresponding L1-GS utterances obtained in the previous step, that is, without the need for the L1 reference. The outputs of the pronunciation-correction model are referred to as L2-GS utterances since they are generated directly from L2 utterances (i.e., in a reference-free fashion). Critical in this process is the generation of the speaker embeddings, first described herein.

### Extracting Speaker-Independent Speech Embeddings

An acoustic model (AM) is used to generate a speaker-independent (SI) speech embedding for an input (L1 or L2) utterance. Our AM is a Factorized Time Delayed Neural Network (TDNN-F) (42, 43), a feedforward neural network that utilizes time-delayed input in its hidden layers to model long term temporal dependencies. TDNN-F achieves performance on Large Vocabulary Continuous Speech Recognition (LVCSR) tasks that is comparable to that of AMs based on recurrent structures (e.g., Bi-LSTMs), but is more efficient during training and inference due to its feedforward nature (42). To produce an SI speech embedding, each acoustic feature vector (40-dim MFCC) is concatenated with an i-vector (100-dim) of the corresponding speaker (44) and used them to the AM, which then is trained on a large corpus from a few thousand native speakers (Librispeech (45)). The AM is trained following the Kaldi (46) “tdnn_1d” configuration of the TDNN-F model. The full training set (960 hours) is used in the Librispeech corpus for acoustic modeling. A subset (200 hours) of the training set is used to train the i-vector extractor.

Three different speech embeddings were evaluated:
1. Senone phonetic posteriorgram (Senone-PPG): The output from the final softmax layer of the AM, which is high dimensional (6,024 senones) and which contains fine-grained information about the pronunciation pattern in the input utterance.
2. Bottleneck feature (BNF): The output of the layer prior to the final softmax layer of the AM. The BNF contains rich classifiable information for a phoneme recognition task, but lower dimensionality (256).
3. Monophone phonetic posteriorgram (Mono-PPG): The phonetic posteriorgrams are obtained by collapsing the senones into monophone symbols (346 monophones with word positions, e.g., word-initials, work-finals). For each monophone symbol, the probability mass of all the senones that share the same root monophone are aggregated. FIG. 2 visualizes the Mono-PPG of a spoken word. The visualization of the other two speech embeddings are omitted since they are more difficult to interpret.

### Generating a Reference-Based Golden-Speaker (L1-GS): Step 1

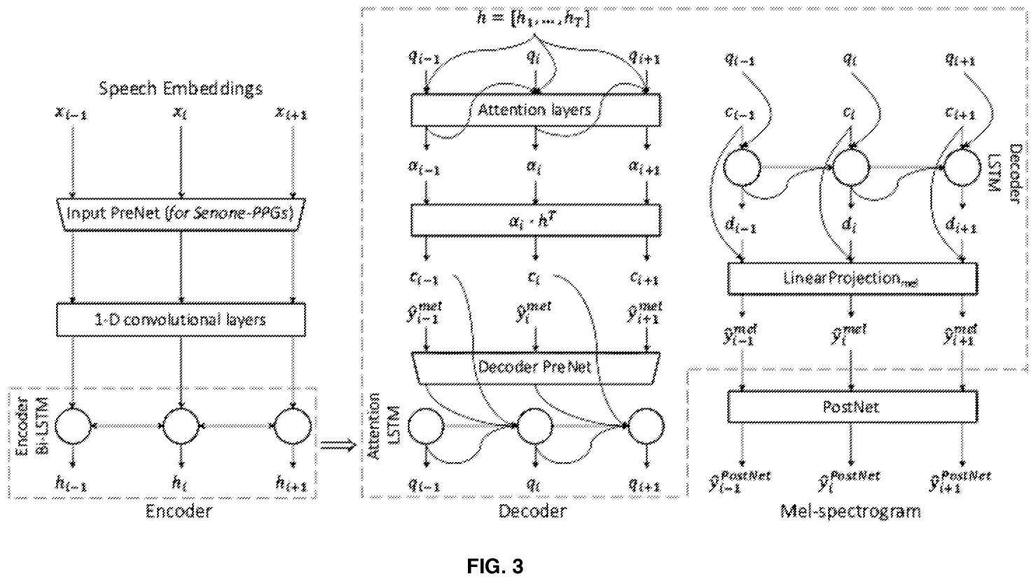

The speech synthesizer is based on a modified Tacotron2 architecture (9) and is illustrated in FIG. 3. The model follows a general encoder-decoder (or seq2seq) paradigm with an attention mechanism. Conceptually, an encoder-decoder architecture uses an encoder (usually a recurrent neural network; RNN) to “consume” input sequences and generate a high-level hidden representation sequence. Then, a decoder (an RNN with an attention mechanism) processes the hidden representation sequence. The attention mechanism allows the decoder to decide which parts of the hidden representation sequence contain useful information to make the predictions. At each output time step, the attention mechanism computes an attention context vector (a weighted sum of the hidden representation sequence) to summarize the contextual information. The decoder RNN reads the attention context vectors and predicts the output sequence in an autoregressive manner.

The speech synthesizer takes the speech embeddings as input. Then, if the input speech embeddings have high dimensionality (e.g., Senone-PPGs), their dimensions are reduced through a learnable input PreNet. This step is essential for the model to converge when using high-dimensional speech embeddings as input. For speech embeddings with lower dimensionality, such as Mono-PPGs and BNFs, the input PreNet is skipped. The speech embeddings are then passed through multiple 1-D convolutional layers, which model longer-term context. Next, an encoder (one Bi-LSTM) converts the convolutions into a hidden linguistic representation sequence. Finally, the hidden linguistic representation sequence is passed to the decoder, which consists of a location-sensitive attention mechanism (47) and a decoder LSTM, to predict the raw Mel-spectrogram. It is noted that the input and output sequences of the speech synthesizer have the same length, and thus, the speech synthesizer only models the speaker identity and retains the phonetic and prosodic cues carried by the input speech embeddings. In a similar conversion model in a recent study (48) it was observed that if the temporal structure, such as the length, of the input and output sequences were the same, then removing the attention module did not hurt performance, which suggests a potential path to further simplify the model structure of the speech synthesizer built herein.

Formally, let [a; b] represent the operation of concatenating vectors a and b, h=(h₁, . . . , h_{T}) be the full sequence of hidden linguistic representation from the encoder and (·)^{T} denote the matrix transpose. At the i-th decoding time step, applying the location-sensitive attention mechanism, the attention context vector cᵢ is the weighted sum of h,

$${c}_{i} = {α}_{i} \cdot {h}^{T} , \qquad ( 1 )$$

$${α}_{i} = AttentionLayers ( {q}_{i} , {α}_{i - 1} , h ) = [ {α}_{i}^{1} , … {α}_{i}^{T} ] , \qquad ( 2 )$$

$${q}_{i} = AttentionLSTM ( {q}_{i - 1} , [ {c}_{i - 1} ; DecoderPreNe t ( {\hat{y}}_{i - 1}^{m e l} ) ] ) , \qquad ( 3 )$$

$${α}_{i}^{j} = \frac{exp ( {e}_{ij} )}{{\sum }_{j = 1} exp ( {e}_{ij} )} , \qquad ( 4 )$$

$${e}_{ij} = {v}^{T} tanh ( {Wq}_{i} + {Vh}_{j} + {Uf}_{i}^{j} + b ) , \qquad ( 5 )$$

$${f}_{i} = F * {α}_{i - 1} = [ {f}_{i}^{1} , … , {f}_{i}^{T} ] , F ∈ {R}^{k \times r} . \qquad ( 6 )$$

αᵢ=[αᵢ¹, . . . αᵢ^{T}] are the attention weights. qᵢ is the output of the attention LSTM, and ŷᵢ₋₁^{mel} is the predicted raw Mel-spectrum from the previous time step. v, W, V, U, b, F are learnable parameters of the attention layers. F contains k 1-D learnable kernels with kernel size r, and fᵢ^{j}∈R^{k} is the result of convolving αᵢ₋₁ at position j with F.

Next, let dᵢ be the output of the decoder LSTM at decoding time step i, and ŷᵢ^{mel} be the new raw Mel-spectrum prediction, then,

dᵢ=DecoderLSTM(dᵢ₋₁,[qᵢ;cᵢ]), (7)

ŷᵢ^{mel}=LinearProjectionₘₑₗ([dᵢ;cᵢ]). (8)

At each time step, to determine if the decoder prediction reaches the end of an utterance, a binary stop token is computed (1: stop; 0: continue) using a separate trainable fully connected layer,

$${\hat{y}}_{i}^{stop} = \{ \begin{matrix}1 & Sigmoid ( {LinearProjection}_{stop} ( [ {d}_{i} ; {c}_{i} ] ) ) \geq 0.5 \\ 0 & Sigmoid ( {LinearProjection}_{stop} ( [ {d}_{i} ; {c}_{i} ] ) ) < 0.5\end{matrix} \qquad ( 9 )$$

The original Tacotron 2 was designed to accept character sequences as input, which are significantly shorter than our speech embedding sequences. For example, each sentence in our corpus contains 41 characters on average, whereas the corresponding speech embedding sequence has a few hundred frames. Therefore, the vanilla location-sensitive attention mechanism might fail, as pointed out in (35). As a result, the inference would be ill-conditioned and would generate non-intelligible speech. Following a preliminary study (27) of this work, a locality constraint is added to the attention mechanism. Speech signals have a strong temporal-continuity and progressive nature. To capture the phonetic context, one only need to look at the speech embeddings in a small local window. Inspired by this, at each decoding step during training, the attention mechanism is constrained to only consider the hidden linguistic representation within a fixed window centered on the current frame, i.e., let,

\tilde{h}=[0, . . . ,0,h_{i-w}, . . . ,hᵢ, . . . ,h_{i+w},0, . . . ,0], (10)

where w is the window size. Consequentially, eq. (2) is replaced with eq. (11),

αᵢ=AttentionLayers(qᵢ,αᵢ₋₁,\tilde{h}). (11)

Finally, to further improve the synthesis quality, the speech synthesizer appends a PostNet after the decoder to predict residual spectral details from the raw Mel-spectrum prediction, and then adds the spectral residuals to the raw Mel-spectrum,

ŷᵢ^{PostNet}=ŷᵢ^{mel}+PostNet(ŷᵢ^{mel}). (12)

The advantage of the PostNet is that it can see the entire decoded sequence. Therefore, the PostNet can use both past and future information to correct the prediction error for each individual frame (49).

The loss function for training this speech synthesizer is,

L=w₁(∥Yₘₑₗ−Ŷₘₑₗ^{Decoder}∥₂)+w₂CE(Yₛₜₒₚ,Ŷₛₜₒₚ), (13)

where Yₘₑₗ is the ground-truth Mel-spectrogram; Ŷₘₑₗ^{Decoder} and Ŷₘₑₗ^{PostNet} are the predicted Mel-spectrograms from the decoder and PostNet, respectively; Yₛₜₒₚ and Ŷₛₜₒₚ are the ground-truth and predicted stop token sequences; CE(·) is the cross-entropy loss; w₁ and w₂ control the relative importance of each loss term.

The predicted Mel-spectrograms are converted back to audio waveforms using a WaveGlow neural vocoder trained on the L2 utterances. The L2 synthesizer is then driven with a set of utterances from the reference L1 speaker, to produce the L1-GS utterances that are used in Step 2.

### Generating the Reference-Free Golden Speaker (L2-GS) Via Pronunciation-Correction: Step 2

The pronunciation-correction model is based on a state-of-the-art seq2seq VC system proposed by Zhang et al. (12). This system was chosen as a baseline since it outperformed the best system in the Voice Conversion Challenge 2018 (37). The rationale behind using a VC system as the pronunciation-correction model is that VC can convert both the voice identity and the accent to match the target speaker. The L2 speaker and the L1-GS are treated as the source and target speakers in a VC task, respectively. Since the two speakers already share the same voice identity, the VC model only needs to match the accent of the target speaker, i.e., the golden speaker. During the inference stage, L2 speech is directly inputted into the pronunciation-correction model, and the output will share similar pronunciation patterns as the L1-GS. The difficulty of this procedure is that L2 speakers tend to have disfluencies, hesitations, and inconsistent pronunciations, making the conversion much harder than converting between two native speakers, as discussed in prior literature (11). To overcome this difficulty, a variation of the forward-and-backward decoding technique is used (13, 14), in addition to the baseline pronunciation model, to achieve better pronunciation-correction performance.

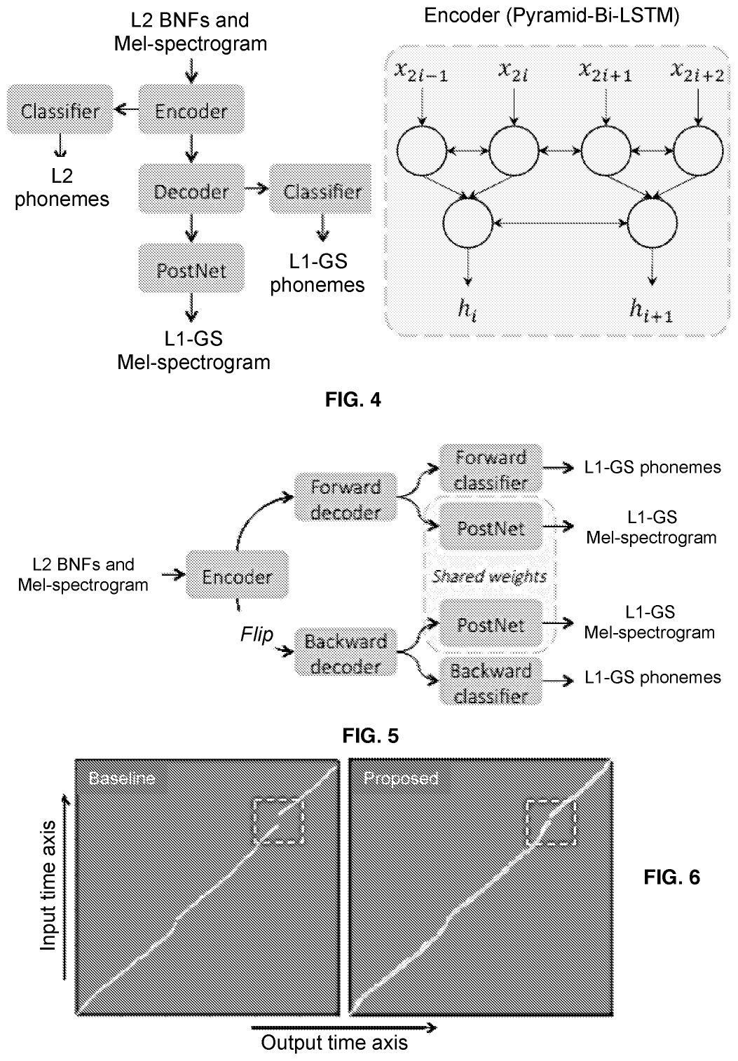

The baseline system also is based on an encoder-decoder paradigm with an attention mechanism. FIG. 4 shows an overview of the baseline system. Unlike conventional frame-by-frame VC systems (e.g., GMM, feedforward neural networks), which need time-alignment between the source and target speakers to generate the training frame pairs, seq2seq systems use an attention mechanism to produce learnable alignments between the input and output sequences. Therefore, they can also adjust for prosodic differences, for example, pitch, duration, and stressing) between the input and output sequences. This is crucial since prosody errors also contribute to foreign accentedness.

Specifically, let xᵢ be the i-th feature vector in the sequence, the input X=[x₁, . . . , x_{T}_{ᵢₙ}] to the conversion system is the concatenation of the bottleneck features, i.e., BNFs, and Mel-spectrogram computed from the L2 utterance. The output sequence is denoted by Yₘₑₗ=[y₁^{mel}, . . . , y_{T}_{ₒᵤₜ}^{mel}] where yᵢ^{mel} is the i-th Mel-spectrum of the L1-GS utterance. A two-layer Pyramid-Bi-LSTM encoder (50) with a down-sampling rate of two consumes the input sequence and produces the encoder hidden embeddings

$$h = [ {h}_{1} , … , {h}_{⌊ \frac{i}{2} ⌋} , … , {h}_{⌊ \frac{{T}_{in}}{2} ⌋} ] , where {h}_{⌊ \frac{i}{2} ⌋}$$

is one encoder hidden embedding vector, and └·┘ is the floor-rounding operator. The first Bi-LSTM layer does the recurrent computations on X and outputs h_{layer1}=[h_{layer1}¹, . . . , h_{layer1}^{T}^{ᵢₙ}]. Each two of the consecutive frames in h_{layer1} are concatenated to form [[h_{layer1}¹; h_{layer1}²], . . . , [h_{layer1}^{t}^{ᵢₙ}⁻¹; h_{layer1}^{T}^{ᵢₙ}]]. Finally, the concatenated vectors are fed to the second Bi-LSTM layer to produce h. In the case that there is an odd number of frames in the input sequence, the last frame is dropped, which is generally a silent frame. The down-sampling effectively reduces the sequence length of the input, which speeds up the encoder computation by a factor of two and makes it easier for the attention mechanism to learn a meaningful alignment between the input and output sequences.

The decoder in this model has a similar neural-network structure as the speech synthesizer decoder (FIG. 3), with only two differences: (1) to replicate Zhang et al. (12), the forward-attention technique (51) is used instead of eq. (4) to normalize the attention weights; (2) the locality constraint defined in equations (10) and (11) is discarded. The decoder predicts the output raw Mel-spectrogram sequence Ŷₘₑₗ^{Decoder}=[ŷ₁^{mel}, . . . , ŷ_{T}_{ₒᵤₜ}^{mel}] and the stop token sequence Ŷₛₜₒₚ=[ŷ₁^{stop}, . . . , ŷ_{T}_{ₒᵤₜ}^{stop}] following equations (8) and (9), respectively. Ŷₘₑₗ^{Decoder} is also processed through a PostNet to generate a residual-compensated Mel spectrogram Ŷₘₑₗ^{PostNet}, following eq. (12). As in the previous step, Ŷₘₑₗ^{PostNet} is converted back to audio waveforms using a WaveGlow neural vocoder trained on the L2 utterances.

In addition, the baseline system uses multi-task learning (52, 53) to make the synthesized pronunciations more stable. Two independent phoneme classifiers, each containing one fully-connected layer and a softmax operation, are added to predict the input and output phoneme sequences Ŷ_{inP}=[ŷ₁^{inP}, . . . , ŷ_{T}_{ᵢₙ}^{inP}] and Ŷ_{outP}=[ŷ₁^{outP}, . . . , ŷ_{T}_{ₒᵤₜ}^{outP}], respectively. These phoneme classifiers are only used during training and are discarded in inference. cᵢ and qᵢ are defined in the same manner as in equations (1) and (3).

ŷᵢ^{inP}=PhonemeClassifierᵢₙ(hᵢ) (14)

ŷᵢ^{outP}=PhonemeClassifierₒᵤₜ([qᵢ;cᵢ]) (15)

The final loss function of the baseline system becomes,

L_{base}=w₁(∥Yₘₑₗ−Ŷₘₑₗ^{Decoder}∥₂+∥Yₘₑₗ−Ŷₘₑₗ^{PostNet}∥₂)+w₂CE(Yₛₜₒₚ,Ŷₛₜₒₚ)+w₃(CE(Y_{inP},Ŷ_{inP})+CE(Y_{outP},Ŷ_{outP})) (16)

Where Y_{inP}, Y_{outP} are the ground-truth input and output phoneme sequence, respectively.

To improve predictive performance, a modification to the baseline system is made that applies forward-and-backward decoding during the training process. The forward-and-backward decoding technique maintains two separate decoders, i.e., the forward and backward decoders. The forward decoder processes the encoder outputs in the forward direction, whereas the backward decoder reads the encoder outputs reversely. Different variations of this technique have been applied to TTS (14) and ASR (13). FIG. 5 shows an overview of this procedure. During training, a backward decoder was added to the baseline model. The backward decoder has the same structure as the existing decoder (denoted as the forward decoder) but with a different set of weights. The backward decoder functions the same as the forward decoder except that it processes the encoder's output in reverse order and predicts the output Mel-spectrogram Ŷₘₑₗ^{bwd} reversely as well. The backward decoder, like its forward counterpart, also predicts its own set of stop tokens Ŷₛₜₒₚ^{bwd}, output phoneme labels Ŷ_{outP}^{bwd}, and uses the shared PostNet to predict a refined Mel-spectrogram Ŷ_{mel-PostNet}^{bwd}. The loss terms contributed by adding this backward decoder are,

L_{bwd}=w₁(∥Yₘₑₗ−Ŷₘₑₗ^{bwd}∥₂+∥Yₘₑₗ−Ŷ_{mel-PostNet}^{bwd}∥₂)+w₂CE(Yₛₜₒₚ,Yₛₜₒₚ^{bwd})+w₃CE(Y_{outP},Y_{outP}^{bwd}). (17)

Additionally, to force the two decoders to learn complementary information from each other, the two decoders are trained to produce the same attention weights by including the following loss term,

Lₐₜₜ=w₄∥α_{fwd}−α_{bwd}∥₂, (18)

where α_{fwd} and α_{bwd} are the attention weights of the forward and backward decoder, respectively.
The final loss term of the proposed system is,

L_{proposed}=L_{base}+L_{bwd}+Lₐₜₜ. (19)

The rationale behind the forward-and-backward decoding is that RNNs are generally more accurate at the initial decoding time steps, but performance decreases as the predicted sequence becomes longer because the prediction errors accumulate due to the autoregression. By including two decoders that model the input data in two different directions, and by constraining them to produce similar attention weights, the two decoders are forced to incorporate information from both the past and future, thus improving their modeling power. Note that both decoders are only used during training. During inference time, either the forward or backward decoder are kept and the other is discarded. Therefore, the model size is exactly the same as the baseline model.

### WaveGlow Vocoder

A WaveGlow vocoder (15) is used to convert the output of the speech synthesizer back into a speech waveform. WaveGlow is a flow-based (54) network capable of generating high-quality speech from Mel-spectrograms. It takes samples from a zero mean spherical Gaussian (with variance a) with the same number of dimensions as the desired output and passes those samples through a series of layers that transform the simple distribution to one that has the desired distribution. In the case of training a vocoder, WaveGlow is used to model the distribution of audio samples conditioned on a Mel-spectrogram. During inference, random samples from the zero-mean spherical Gaussian are concatenated with the up-sampled (matching the speech sampling rate) Mel-spectrogram to predict the audio samples. WaveGlow can achieve real-time inference speed, whereas WaveNet takes a long time to synthesize an utterance due to its auto-regressive nature. For more details about the WaveGlow vocoder, see Prenger et al. (15), which also showed that WaveGlow generates speech with quality comparable to WaveNet.

### Experimental Setup

The FAC system is evaluated on a thorough set of objective measures (e.g., word error rates, Mel Cepstral distortion) and subjective measures (degree of foreign accent, audio quality, and voice similarity.) For the FAC task (training the speech synthesizers, WaveGlow neural vocoders, and pronunciation-correction models), one native speaker (BDL; American accent) from CMU-ARCTIC corpus (55) and two non-native speakers (YKWK, Korean; TXHC, Chinese) from the L2-ARCTIC corpus (56; psi.engr.tamu.edu/12-arctic-corpus) were used. BDL was chosen at the native speaker since the AM used herein has reasonable recognition accuracy on his speech (Table 1). If the AM were to perform poorly on the native speaker, then the L1-GS utterances would include more mispronunciations and therefore degrade the overall accent conversion performance. The data from all speakers was split into non-overlapping training (1032 utterances), validation (50 utterances), and testing (50 utterances) sets. Recordings from BDL were sampled at 16 kHz. Recordings in the L2-ARCTIC corpus were resampled from 44.1 kHz to 16 kHz to match BDL's sampling rate and were pre-processed with Audacity (57) to remove any ambient background noise. In all FAC tasks, 80-dim Mel-spectrogram were extracted with a 10 ms shift and 64 ms window size. All neural network models were implemented in PyTorch (58) and trained with an NVIDIA Tesla P100 GPU. In all experiments, speaker-dependent WaveGlow neural vocoders for L2 speakers were trained using the official implementation provided by Prenger et al. (15; github.com/NVIDIA/waveglow).

### Example 2

### Evaluating the Reference-Based Golden Speaker (L1-GS)

The following three systems were constructed and compared their performance was compared in generating L1-GS utterances. The objectives of this experiment were to determine the optimal speech embedding, and more importantly, to establish that L1-GS utterances captured the native accent and the L2 speaker identity, which is critical since they would be used as targets for the reference-free FAC task. Details of the model configurations and training are summarized in Example 4.

Senone-PPG: use the senone-PPG as the input (6,024 dimensions).

Mono-PPG: use the monophone PPG as the input (346 dimensions).

BNF: use the bottleneck feature vector as the input (256 dimensions).

To generate the L1-GS utterances for testing, the three speech embeddings were extracted from speaker BDL's test set and drove the systems with their respective input. The output Mel-spectrograms were then converted to speech through the WaveGlow vocoders.

### Objective Evaluation

In a first experiment, the word error rate (WER) of L1-GS utterances synthesized was computed using each of the three speaker embeddings. In this case, the speech recognizer consisted of the TDNN-F acoustic model combined with an unpruned 3-gram language model trained on the Librispeech transcripts. As a reference, WERs on test utterances also were computed from the L1 speaker (BDL) and the two L2 speakers (YKWK, TXHC). Results are summarized in Table 1. L1-GS utterances from the three systems achieve lower WERs than the corresponding utterances from the L2 speakers. Since the acoustic model had been trained on American English speech, a reduction in lower WERs can be interpreted as a reduction in the foreign-accentedness. The BNF system performs markedly better than the other two systems, achieving WERs that are close to those on L1 utterances. The Senone-PPG system performed the worst, despite the fact that it contains the most fine-grained triphone-level phonetic information.

TABLE 1
Word error rates (%) on test utterances and the original speech.

| | | | | Original |
|---|---|---|---|---|
| | Senone-PPG | Mono-PPG | BNF | speech |
| YKWK | 37.56 | 23.30 | 9.50 | 45.82 |
| TXHC | 28.05 | 23.53 | 7.47 | 44.57 |
| Average | 32.81 | 23.42 | 8.49 | 45.20 |
| BDL | | N/A | | 4.98 |

### Subjective Evaluation

To further evaluate the three L1-GS systems, formal listening tests were conducted to rate three perceptual attributes of the synthesized speech: accentedness, acoustic quality, and voice similarity. All listening tests were conducted through the Amazon Mechanical Turk platform (mturk.com). Instructions were given in each test to help the participants focus on the target speech attribute. All tests included five calibration samples to detect cheating behaviors, as suggested by Buchholz and Latorre (59); responses from participants who were deemed to have cheated were excluded. Ratings for the calibration samples were excluded, too. All participants received monetary compensation. All samples were randomly selected from the test set, and the presentation order of samples in every listening test was randomized and counter-balanced. All participants resided in the United States at the time of the recruitment and passed a qualification test where they identified several regional dialects in the United States. All participants were self-reported native English speakers. All listening tests in this study have been approved by the Institutional Review Board of Texas A&M University.

Accentedness test: Listeners were asked to rate the foreign accentedness of an utterance on a nine-point Likert-scale (1: no foreign accent; 9: heavily accented), which is used in the pronunciation training community (60). Listeners were told that the native accent in this task was General American. Participants (N=20) rated 20 randomly selected utterances per system per L2 speaker. The utterances shared the same linguistic content in all conditions to ensure a fair comparison. As a reference, listeners also rated the same set of sentences for the L1 and L2 speakers. The results are summarized in the first row of Table 2. L1-GS utterances from the three systems were rated significantly (p«0.001) more native-like than the original L2 speech, though not as much as the original L1 speech. Among the three systems, the BNF system significantly outperformed Mono-PPG, while Mono-PPG was rated significantly more native-like than Senone-PPG, all with p«0.001.

Acoustic quality: Listeners were asked to rate the acoustic quality of an utterance using a standard five-point (1: poor; 2: bad; 3: fair; 4: good; 5: excellent) Mean Opinion Score (MOS) (61). Participants (N=20) listened to 20 randomly-selected sentences per L2 speaker per system. As in the accentedness test, listeners also rated the original utterances from the L1 and L2 speakers. The results are summarized in the second row of Table 2. As expected, the original native speech received the highest MOS. Among the three golden speaker voices, BNF achieved the highest MOS compared with the other two systems (p«0.001). The Mono-PPG system obtained better acoustic quality than the Senone-PPG system (p=0.045). Interestingly, L1-GS utterances from the BNF system received higher MOS than the original L2 speech (3.78 vs. 3.70, p=0.02), a surprising result.

TABLE 2
Accentedness (the lower, the better) and MOS ratings (the higher, the better)
of the golden, native, and non-native speakers; the error ranges show the 95%
confidence intervals; the same convention applies to the rest of the results.

| | Senone-PPG | Mono-PPG | BNF | Original L2 | Original L1 |
|---|---|---|---|---|---|
| Accentedness | 6.01 ± 0.26 | 5.48 ± 0.19 | 4.30 ± 0.16 | 6.77 ± 0.20 | 1.04 ± 0.04 |
| MOS | 3.43 ± 0.13 | 3.54 ± 0.09 | 3.78 ± 0.05 | 3.70 ± 0.06 | 4.63 ± 0.06 |

Voice similarity test: Listeners were presented with a pair of speech samples: an L1-GS synthesis, and the original utterance from the corresponding L2 speaker. In the test, listeners first had to decide if the two samples were from the same speaker, and then rate their confidence level on a seven-point scale (1: not confident at all; 3: somewhat confident; 5: quite a bit confident; 7: extremely confident) (1, 27). To minimize the influence of accent, the two utterances had different linguistic contents and were played in reverse, following (1). For each system, participants (N=20) rated 10 utterance pairs per speaker (20 utterance pairs for each system). Results are summarized in Table 3. Across the three systems, more than 70% of the listeners were “quite a bit” confident (4.82-4.93 out of 7) that the L1-GS utterance and the original L2 utterance had the same voice identity. Significance tests showed that there was no statistically significant difference between the preference percentages for the three systems.

TABLE 3
Voice similarity ratings. The first row shows the percentage of the
raters that believed the synthesis and the reference audio clip were
produced by the same speaker; the second row is the average rating
of these raters' confidence level when they made the choice.

| | Senone-PPG | Mono-PPG | BNF |
|---|---|---|---|
| Prefer “same | 70.00 ± 9.12% | 71.25 ± 6.38% | 73.75 ± 6.46% |
| speaker” | | | |
| Average rater | 4.82 | 4.89 | 4.93 |
| confidence | | | |

These results show that the BNF system outperforms the other two systems significantly in both objective and subjective measures. As such, evaluation on the BNF system, i.e., target L1-GS utterances for the reference-free (pronunciation-correction) system are those from the BNF system.

Both objective and subjective tests suggested that the BNF system outperforms the other two, both in terms of audio quality and native accentedness. Further, it was found that L1-GS utterances on the BNF system achieve similar WERs as the original utterances from the L1 speaker, a remarkable result that further supports the effectiveness of the system in reducing foreign accents. The majority of the human raters (73.75%) had high confidence that the BNF L1-GS shared the same voice identity as the target L2 speaker, suggesting that the accent conversion was also able to preserve the desired, i.e., the L2 speaker's, voice identity. A surprising result from the listening tests is that BNF L1-GS utterances were rated to have higher audio quality than the original natural speech from the L2 speaker. Although this result speaks of the high acoustic quality that the BNF L1-GS system is able to achieve, it is likely that native listeners associated acoustic quality with intelligibility, rating the original foreign-accented speech to be of lower acoustic quality because of that; see Felps et al. (1).

Two probable factors explain why BNFs outperformed the other two speech embeddings. First, during the training process, it was observed that the BNF system converges to a better terminal validation loss. This result suggests that the speech synthesizer can model Mel-spectrograms more accurately using BNFs as the input rather than the other two speech embeddings. Second, although BNFs and PPGs contain similar linguistic information, the process that converted BNFs to PPGs was a phoneme classification task. Therefore, errors that do not exist in BNFs may occur in PPGs due to the enforcement of the extra classification step. Those additional classification errors are then translated to the speech synthesizer as mispronunciations and speech artifacts. One possible explanation for differences between the two PPGs is dimensionality reduction strategies; the monophone-PPG system used an empirical rule (reducing senones to monophones) to summarize the high-dimensional senone-PPG, while the senone-PPG system constructed a learnable transformation (an input PreNet). Although it is possible for data-driven transforms to outperform empirical rules given enough data, the limited amount of data (˜one hour of speech per speaker) available for the FAC task was probably not enough to produce a good transformation for senone-PPGs.

### Example 3

### Evaluating the Reference-Free Golden Speaker (L2-GS)

The L2 test utterances were directly converted with the proposed pronunciation-correction model and compared it against the baseline systems. Detailed model architecture configurations and training setups are included in Example 4.

Baseline 1: the system of Zhang et al. (12), a state-of-the-art VC system capable of modifying segmental and prosodic attributes between different speakers. The loss function of this system was eq. (16), i.e., L_{base}

Baseline 2: the system of Liu et al. (41). The audio samples were generated by passing the test set utterances through the Liu system (41), which was pre-trained on 105 VCTK (62) speakers. The test samples were provided as a courtesy by Liu et al., and two post-processing steps only were performed to ensure a fair comparison. First, the test samples provided by Liu et al. were resampled from 22.05 kHz to 16 kHz to match the sampling rate of the other systems. Second, the trailing white noises was manually trimmed in some of the test samples. The accent conversion model was pre-trained on VCTK not L2-ARCTIC, which made its stop-token prediction not stable, and some of the synthesized utterances have a few seconds of white noise after the end of speech.

Proposed (without att loss): the proposed system without the attention loss term described in eq. (18). This variation was included to study the contribution of adding the backward decoder alone. The loss function of this system was L_{base}+L_{bwd}.

Proposed: the proposed system with the full forward-and-backward decoding technique, which included both the backward decoder and the attention loss term. The loss function of this system was eq. (19), i.e., L_{base}+L_{bwd}+Lₐₜₜ.

For both variations of the proposed system, accent conversion was performed using the backward decoder during testing since it produced significantly better-quality speech compared to the forward decoder on the validation set. Example 4 has a qualitative comparison between the two decoders.

### Objective Evaluations

For objective evaluations, three measures were computed, as suggested by (12), plus WER as a fourth:

MCD: the Mel-Cepstral Distortion (28) between the L2-GS (actual output) and L1-GS speech (desired output). It was computed on time-aligned (Dynamic Time Warping) Mel-cepstra between the L2-GS and the L1-GS audio. Lower MCD correlates with better spectral predictions. SPTK (63) and the WORLD vocoder (64) were used to extract the Mel-cepstra with a shift size of 10 ms.

F₀ RMSE: the F₀ RMSE between the L2-GS and L1-GS speech on voiced frames. Lower F₀ RMSE represents better pitch conversion performance. The F₀ and voicing features were extracted by the WORLD vocoder with the Harvest pitch tracker (65).

DDUR: the absolute difference in duration between the L2-GS and L1-GS speech. Lower DDUR implies better duration conversion performance.

WER: the word error rate for the L2-GS speech. Ideally, the L2-GS speech should have a lower WER than the original non-native speech, implying that the conversion reduced the foreign accent.

Results are summarized in Table 4. For all measures, the scores between the original L2 speech and the L1-GS speech also were computed as a reference. In addition, the WER of the L1-GS speech was included as an upper-bound. By definition, the other three measures on the L1-GS speech are all zero. For Baseline 2, the WER were only computed since the system was not trained to predict L1-GS, which makes computing the other objective scores ill-defined.

The two variations of the proposed method obtained better WER, MCD, and DDUR scores, while the Baseline 1 method performed slightly better on the F₀ RMSE. More importantly, Baseline 1 and the two variations of the proposed method were able to reduce the WER of the input L2 utterance. The Proposed method (with attention loss) reduced WERs by 20.5% (relative) on average, which was significantly higher than the WER reduction of the Baseline 1 system (6.0% relative). Baseline 2 performed poorly on the WER metric. Among the two variations of the proposed method, the one that included both the backward decoder and attention loss performed equally-well or better on the WER, MCD, and DDUR scores.

TABLE 4
Objective evaluation results of the reference-free FAC
system (pronunciation-correction). The first row in each
block shows the scores between the original L2 utterances
and the L1-GS utterances. The last block shows the average
values of the first two blocks. For all measurements,
a lower value suggests better performance.

| L2 | | WER | MCD | F₀ RMSE | DDUR |
|---|---|---|---|---|---|
| speaker | System | (%) | (dB) | (Hz) | (sec) |
| YKWK | Original | 45.82 | 8.07 | 23.38 | 1.15 |
| | Baseline 1 | 41.31 | 6.26 | 18.43 | 0.18 |
| | Baseline 2 | 82.81 | | N/A | |
| | Proposed (w/o | 36.12 | 6.16 | 19.41 | 0.14 |
| | att loss) | | | | |
| | Proposed | 34.54 | 6.10 | 20.78 | 0.15 |
| | L1-GS | 9.50 | 0.00 | 0.00 | 0.00 |
| TXHC | Original | 44.57 | 8.00 | 25.73 | 1.29 |
| | Baseline 1 | 43.67 | 6.32 | 19.40 | 0.17 |
| | Baseline 2 | 84.39 | | N/A | |
| | Proposed (w/o | 40.05 | 6.26 | 22.33 | 0.15 |
| | att loss) | | | | |
| | Proposed | 37.33 | 6.29 | 21.37 | 0.15 |
| | L1-GS | 7.47 | 0.00 | 0.00 | 0.00 |
| Average | Original | 45.20 | 8.04 | 24.56 | 1.22 |
| | Baseline 1 | 42.49 | 6.29 | 18.92 | 0.18 |
| | Baseline 2 | 83.60 | | N/A | |
| | Proposed (w/o | 38.09 | 6.21 | 20.87 | 0.15 |
| | att loss) | | | | |
| | Proposed | 35.94 | 6.20 | 21.08 | 0.15 |
| | L1-GS | 8.49 | 0.00 | 0.00 | 0.00 |

### Subjective Evaluations

Following the same protocol described in Example 3, participants were asked to rate the accentedness, acoustic quality, and voice similarity of synthesized L2-GS utterances. The samples from the instant system (with the attention loss during training) based on the objective evaluations in Example 3 were used.

Accentedness test. Participants (N=20) rated 20 random samples per speaker per system, as well as the corresponding original audio. Results are compiled in the first row of Table 5. All systems obtained significantly more native-like ratings than the original L2 utterances (p«0.001). More specifically, the Baseline 1 system reduced the accentedness rating by 15.5% (relative) and the Baseline 2 system reduced the accentedness rating by 8.2% (relative), while the Proposed system achieved a 19.0% relative reduction, a difference that was statistically significant (Proposed and Baseline 1, p=0.04; Proposed and Baseline 2, p«0.001). As expected, the original L1 speech was rated less accented than all other systems.

MOS test. Participants (N=20) rated 20 audio samples per speaker per system. The same MOS test was used as in experiment 1 to measure the acoustic quality of the synthesis. Results are shown in the second row of Table 5. The Proposed system achieved significantly better audio quality than the baselines (9.15% relative improvement compared with Baseline 1; 12.59% relative improvement compared with Baseline 2; p«0.001 in both cases).

TABLE 5
Accentedness (the lower, the better) and MOS (the higher, the better) ratings of the reference-
free accent conversion systems and original L1 and L2 utterances. The L1-GS scores are from
the BNF results in Table 2, which serve as an upper-bound for this experiment, since Baseline
1 and the Proposed system used the L1-GS utterances as their training targets.

| | Baseline 1 | Baseline 2 | Proposed | L1-GS | Original L2 | Original L1 |
|---|---|---|---|---|---|---|
| Accentedness | 5.56 ± 0.23 | 6.04 ± 0.31 | 5.33 ± 0.28 | 4.30 ± 0.16 | 6.58 ± 0.26 | 1.07 ± 0.04 |
| MOS | 2.95 ± 0.12 | 2.86 ± 0.12 | 3.22 ± 0.10 | 3.78 ± 0.05 | 3.68 ± 0.10 | 4.80 ± 0.06 |

Voice similarity test. Participants (N=20) rated 10 utterance pairs per speaker per system, i.e., 20 utterance pairs for each system). This last experiment verified that the accent conversion retained the voice identity of the L2 speakers. The results are shown in Table 6. For Baseline 1 and the Proposed system, the majority of the participants thought the synthesis and the reference speech were from the same speaker, and they were “quite a bit confident” (5.00-5.12 out of 7) about their ratings. Although the Proposed system obtained higher ratings than the Baseline 1 system in terms of voice identity, the difference between the preference percentages was not statistically significant (p=0.12), which was expected. The reason is that the input and output speech had different accents, but very similar voice identity. Therefore, both systems were not trained to modify the voice identity of the input audio. As a result, both the Baseline 1 system and the Proposed system were able to keep the voice identity unaltered during the conversion process. The Baseline 2 system, on the other hand, performed significantly worse than Baseline 1 and the Proposed system in terms of voice similarity; on average, 47.5% of the participants thought that the synthesis and the reference speech were from the same speaker, which is lower than chance level, indicating that the syntheses produced by Baseline 2 did not capture the voice identity of the L2 speakers well. This result echoes with the findings of Liu et al. (41), where they also identified voice identify issues of the Baseline 2 system.

TABLE 6
Voice similarity ratings of the reference-free accent conversion task.
The L1-GS scores are from the BNF results in Table 3, which serve
as an upper-bound for this experiment, since Baseline 1 and the Proposed
system used the L1-GS utterances as their training targets.

| | Baseline 1 | Baseline 2 | Proposed | L1-GS |
|---|---|---|---|---|
| Prefer “same | 69.25 ± | 47.50 ± | 73.00 ± | 73.75 ± |
| speaker” | 11.08% | 6.65% | 7.55% | 6.46% |
| Average rater | 5.00 | 4.57 | 5.12 | 4.93 |
| confidence | | | | |

Aside from the objective and subjective scores, an example of the attention weights produced by Baseline 1 and the instant system on a test utterance in FIG. 6 are provided. Qualitatively, it is observe that the attention weights of the Baseline 1 system contained an abnormal jump towards the end of the synthesis, while the instant system produced smooth alignments at the same time steps. Additionally, the instant method appears to have used a broader window to compute the attention context compared with Baseline 1, as reflected by the width of the attention alignment path. Therefore, the instant system utilized more contextual information during the decoding process.

Reference-free FAC was achieved by constructing a pronunciation-correction model that converted L2 utterances directly to match the L1-GS. The results are encouraging; both the baseline model of Zhang et al. (12) (Baseline 1) and the reference-free system were able to reduce the foreign accentedness of the input speech significantly, while retaining the voice identity of the L2 speaker. More importantly, the proposed system outperformed the Baseline 1 system significantly in terms of MOS and accentedness ratings. A possible explanation for this result is that the proposed method computes the alignment between each pair of input and output sequences from two directions at training time. Thus, by forcing the forward and the backward decoders to produce similar alignment weights, the decoders were forced to incorporate information from both the past and future when generating the alignment. During inference time, only one decoder is needed to perform the reference-free accent conversion; therefore, the proposed system consumes exactly the same amount of inference resources as the baseline system. In summary, the better accentedness and audio quality ratings obtained by the proposed system can largely be attributed to the better alignments provided by the forward-and-backward decoding training technique, as illustrated in FIG. 6. The proposed system also outperformed a state-of-the-art reference-free FAC system by Liu et al. (41) (Baseline 2) in all objective and subjective evaluation metrics. The comparison of the proposed method and Baseline 2 shows that there is still a large performance gap between a speaker-specific reference-free FAC system (the proposed method) and a many-to-many reference-free FAC system (Baseline 2), which encourages future work in both areas.

The L2-GS generated by the reference-free FAC was rated as significantly less accented than the L2 speaker, though it still had a noticeable foreign accent compared with the original L1 speech. This suggests that the pronunciation-correction model did not fully eliminate the foreign accent in heavily mispronounced or disfluent speech segments, and therefore some foreign-accent cues from the input were carried over to the output speech. One likely explanation for this result is that the proposed reference-free FAC model can only correct error patterns that have occurred in the training data. Due to the high variability of L2 pronunciations, the amount of training data available for each L2 speaker (˜one hour of speech) was not sufficient to cover a portion of the error patterns manifested in the test data, and therefore those errors were not corrected and resulted in the residual foreign accents in the L2-GS utterances. Finally, the MOS ratings of the pronunciation-correction models were lower than those of the BNF L1-GS, which was expected since the output of the pronunciation-correction model is a re-synthesis of the L1-GS utterances.

### Example 4

### Models

### Model Details of the Speech Synthesizers

Table 7 summarizes the neural network architectures of the three speech synthesizers. It is worth noting that the input PreNet produced a 512-dim summarization from the Senone-PPG, which is higher than the dimensionality of the Mono-PPG and BNF. An experiment was performed on a lower dimensionality (256) in the input PreNet, which led to significant artifacts and mispronunciations. Therefore, the current setting for the Senone-PPG system was used in order to generate intelligible speech syntheses to compare with the other two systems.

The models were trained using the Adam optimizer (68) with a constant learning rate of 1×10⁻⁴ until convergence, which was monitored by the validation loss. A 1×10⁻⁶ weight decay (69) and a gradient clipping (70) of 1.0 were applied during training. The batch size was set to 8 and the weight terms w₁ and w₂ in eq. (13) were set to 1.0 and 0.005, based on preliminary experiments (27).

TABLE 7
Neural network architecture of the speech
embedding to Mel-spectrogram synthesizers.

| Component | Parameters |
|---|---|
| Input-dim | 6024 (Senone-PPG); 346 (Mono-PPG); 256 (BNF) |
| Input PreNet | Two fully connected (FC) layers, each has 512 ReLU units, 0.5 dropout |
| (Senone-PPG | (71) rate |
| only) | Output-dim: 512 |
| Convolutional | Three 1-D convolution layers (kernel size 5) |
| layers | Batch normalization (72) after each layer |
| | Output-dim: 512 (Senone-PPG); 346 (Mono-PPG); 256 (BNF) |
| Encoder | One-layer Bi-LSTM, 256 cells in each direction |
| | Output-dim: 512 |
| Decoder PreNet | Two FC layers, each has 256 ReLU units, 0.5 dropout rate |
| | Output-dim: 256 |
| Attention LSTM | One-layer LSTM, 0.1 dropout rate |
| | Output-dim: 512 |
| Attention layers | v in eq. (5) has 256 dims; eq. (6), k = 32, r = 31; eq. (10), w = 20 |
| Decoder LSTM | One-layer LSTM, 0.1 dropout rate |
| | Output-dim: 512 |
| PostNet | Five 1-D convolution layers (kernel size 5), 0.5 dropout rate |
| | 512 channels in first four layers and 80 channels in last layer |
| | Output-dim: 80 |

### Model Details of the Pronunciation-Correction Models

Table 8 summarizes the model details of the Baseline 1 pronunciation-correction model. On top of the Baseline 1 model, the Proposed model adds a backward decoder that has the same structure (attention modules, decoder LSTM, and decoder PreNet) as the Baseline 1 model's decoder. The phoneme prediction ground-truth labels were per-frame phoneme labels (with word positions) that were produced by force-aligning the audio to its orthographic transcriptions. It is noted that the phoneme predictions were only required in training, not testing. For both models, the training was performed with the Adam optimizer with a weight decay of 1×10⁻⁶ and a gradient clip of 1.0. The initial learning rate was 1×10⁻³ and was kept constant for the first 20 epochs, then exponentially decreased by a factor of 0.99 at each epoch for the next 280 epochs, and then kept constant at the terminal learning rate. The batch size was 16. The loss term weights w₁, w₂, w₃, and w₄ in equations (16)-(19) were empirically set to 1.0, 0.05, 0.5, and 100.0.

TABLE 8
Neural network architecture of the baseline pronunciation-correction model.

| Component | Parameters |
|---|---|
| Input layer | 80-dim Mel-spectrum + 256-dim BNF |
| Encoder | Two-layer Pyramid Bi-LSTM, 256 cells/direction/layer |
| | Frame sub-sampling rate: 2 |
| | With layer normalization (73) |
| | Output-dim: 512 |
| Decoder PreNet | Two FC layers, each has 256 ReLU units, 0.5 dropout |
| | rate |
| | Output-dim: 256 |
| Attention mechanism | One-layer LSTM |
| | Forward-attention technique (51) for attention weights |
| | Output-dim: 512 |
| Decoder LSTM | One-layer LSTM |
| | Output-dim: 512 |
| PostNet | Five 1-D convolution layers (kernel size 5), 0.5 dropout |
| | rate |
| | 512 channels in first four layers and 80 channels in last |
| | layer |
| | Output-dim: 80 |
| Input Phoneme Classifier | One FC layer + softmax |
| | Output-dim: 346 |
| Output Phoneme Classifier | One FC layer + softmax |
| | Output-dim: 346 |

### Quantitative Comparison Between the Forward and Backward Decoder of the System

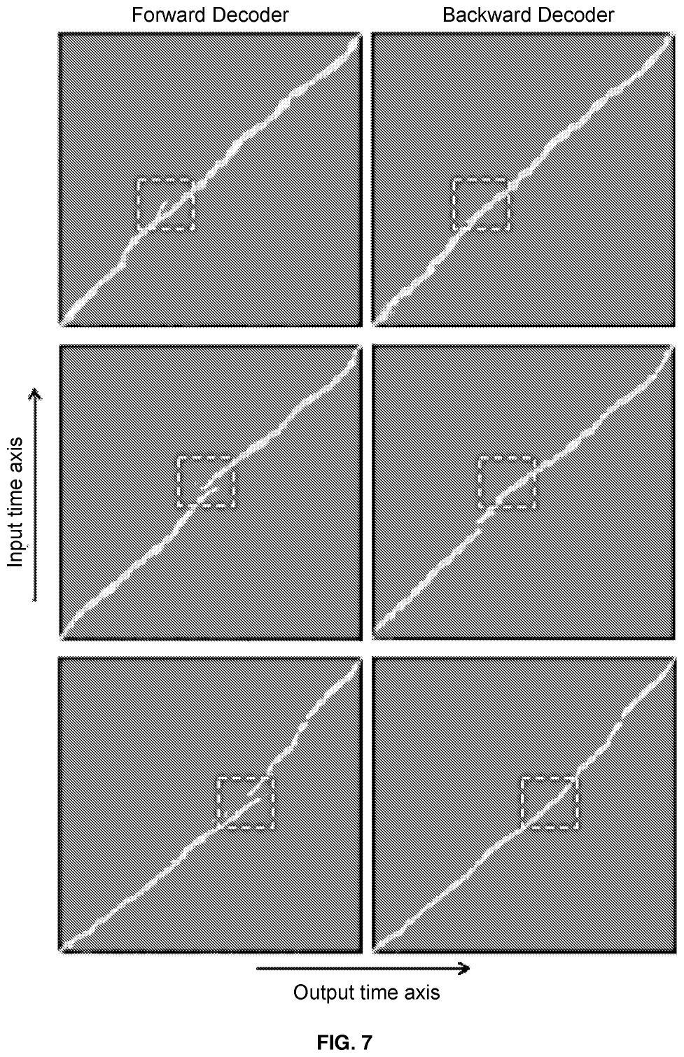

As a qualitative comparison between the forward and backward decoder in the proposed system, the attention weights generated by both decoders on a few utterances from the validation set are plotted. Good alignment of the attention weights generally indicates better performance. FIG. 7 shows that the backward decoder produces attention weights that have less discontinuity, which may explain why the backward decoder generates speech with better quality compared to the forward decoder.

The following references are cited herein.
1. D. Felps, H. Bortfeld, and R. Gutierrez-Osuna, Speech Communication, vol. 51, no. 10, pp. 920-932, 2009.
2. Probst et al., Speech Communication, vol. 37, no. 3, pp. 161-173, 2002.
3. S. Ding et al., Speech Communication, vol. 115, pp. 51-66, 2019.
4. R. Wang and J. Lu, Speech Communication, vol. 53, no. 2, pp. 175-184, 2011.
5. O. Turk and L. M. Arslan, Subband based voice conversion, in Seventh International Conference on Spoken Language Processing, 2002.
6. Sun et al., Interspeech, pp. 322-326, 2016.
7. Oshima et al., Interspeech, pp. 299-303, 2015.
8. Biadsy et al., “Interspeech, pp. 4115-4119, 2019.
9. Shen et al., IEEE International Conference on Acoustics, Speech, and Signal Processing (ICASSP), pp. 4779-4783, 2018.
10. Xie et al., Interspeech, pp. 287-291, 2016.
11. G. Zhao and R. Gutierrez-Osuna, IEEE/ACM Transactions on Audio, Speech, and Language Processing, vol. 27, no. 10, pp. 1649-1660, 2019.
12. Zhang et al., IEEE International Conference on Acoustics, Speech, and Signal Processing (ICASSP), 6785-6789, 2019.
13. Mimura et al., Interspeech, pp. 2232-2236, 2018.
14. Zheng et al., Interspeech, pp. 1283-1287, 2019.
15. Prenger et al., IEEE International Conference on Acoustics, Speech, and Signal Processing (ICASSP), pp. 3617-3621, 2019.
16. S. H. Mohammadi and A. Kain, Speech Communication, vol. 88, pp. 65-82, 2017.
17. M. Brand, 26th Annual Conference on Computer Graphics and Interactive Techniques, pp. 21-28, 1999.
18. D. Felps et al., IEEE Transactions on Audio, Speech, and Language Processing, vol. 20, no. 8, pp. 2301-2312, 2012.
19. S. Aryal and R. Gutierrez-Osuna, The Journal of the Acoustical Society of America, vol. 137, no. 1, pp. 433-446, 2015.
20. S. Aryal and R. Gutierrez-Osuna, Computer Speech & Language, vol. 36, pp. 260-273, 2016.
21. B. Denby and M. Stone, IEEE International Conference on Acoustics, Speech, and Signal Processing (ICASSP), vol. 1, pp. 1-685, 2004.
22. Mumtaz et al., IEEE Signal Processing Letters, vol. 21, no. 6, pp. 658-662, 2014.
23. Toutios et al, Interspeech, pp. 1492-1496, 2016.
24. S. Aryal and R. Gutierrez-Osuna, IEEE International Conference on Acoustics, Speech, and Signal Processing (ICASSP), pp. 7879-7883, 2014.
25. Zhao et al., IEEE International Conference on Acoustics, Speech, and Signal Processing (ICASSP), pp. 5314-5318, 2018.
26. Hazen et al., IEEE Workshop on Automatic Speech Recognition & Understanding (ASRU), pp. 421-426, 2009.
27. Zhao et al., Interspeech, pp. 2843-2847, 2019.
28. Toda et al., IEEE Transactions on Audio, Speech, and Language Processing, vol. 15, no. 8, pp. 2222-2235, 2007.
29. Wu et al., Multimedia Tools and Applications, vol. 74, no. 22, pp. 9943-9958, 2015.
30. G. Zhao and R. Gutierrez-Osuna, IEEE International Conference on Acoustics, Speech, and Signal Processing (ICASSP), pp. 5525-5529, 2017.
31. Kobayashi et al., Interspeech, pp. 2514-2518, 2014.
32. S. H. Mohammadi and A. Kain, IEEE Spoken Language Technology Workshop, pp. 19-23, 2014.
33. Sun et al., IEEE International Conference on Multimedia and Expo (ICME), pp. 1-6, 2016.
34. Miyoshi et al. Interspeech, pp. 1268-1272, 2017.
35. Zhang et al., IEEE/ACM Transactions on Audio, Speech, and Language Processing, vol.
27, no. 3, pp. 631-644, 2019.
36. Oord et al., “ISCA Workshop on Speech Synthesis, p. 125, 2016.
37. Lorenzo-Trueba et al., Odyssey: The Speaker and Language Recognition Workshop, pp. 195-202, 2018.
38. Zhang et al, IEEE/ACM Transactions on Audio, Speech, and Language Processing, vol. 28, pp. 540-552, 2019.
39. Tanaka et al, IEEE International Conference on Acoustics, Speech, and Signal
Processing (ICASSP), pp. 6805-6809, 2019.
40. H. Kameoka et al., ConvS2S-VC: Fully convolutional sequence-to-sequence voice conversion, arXiv preprint arXiv:1811.01609, 2018.
41. S. Liu et al., IEEE International Conference on Acoustics, Speech, and Signal Processing (ICASSP), pp. 6289-6293, 2020.
42. D. Povey et al., Interspeech, pp. 3743-3747, 2018.
43. V. Peddinti et al., pp. 3214-3218, 2015.
44. N. Dehak et al., IEEE Transactions on Audio, Speech, and Language Processing, vol. 19, no. 4, pp. 788-798, 2011.
45. V. Panayotov et al., IEEE International Conference on Acoustics, Speech and Signal Processing (ICASSP), pp. 5206-5210, 2015.
46. D. Povey et al., IEEE Workshop on Automatic Speech Recognition & Understanding (ASRU), 2011.
47. J. K. Chorowski et al., Advances in Neural Information Processing Systems, pp. 577-585, 2015.
48. Liu et al., Non-Parallel Voice Conversion with Autoregressive Conversion Model and Duration Adjustment.
49. Y. Wang et al., Interspeech, pp. 4006-4010, 2017.
50. Chan et al., IEEE International Conference on Acoustics, Speech and Signal Processing (ICASSP), pp. 4960-4964, 2016.
51. Zhang et al., IEEE International Conference on Acoustics, Speech, and Signal
Processing (ICASSP), pp. 4789-4793, 2018.
52. S. Ruder, An overview of multi-task learning in deep neural networks, arXiv preprint arXiv:1706.05098, 2017.
53. Y. Zhang and Q. Yang, A survey on multi-task learning, arXiv preprint arXiv:1707.08114, 2017.
54. D. P. Kingma and P. Dhariwal, Advances in Neural Information Processing Systems, pp. 10236-10245, 2018.
55. J. Kominek and A. W. Black, ISCA Workshop on Speech Synthesis, pp. 223-224, 2004.
56. Zhao et al., Interspeech, pp. 2783-2787, 2018.
57. Audacity® Online. Available: www.audacityteam.org.
58. Paszke et al., Advances in Neural Information Processing Systems, pp. 8024-8035, 2019.
59. S. Buchholz and J. Latorre, Interspeech, pp. 3053-3056, 2011.
60. M. Munro and T. Derwing, Language Learning, vol. 45, no. 1, pp. 73-97, 1995.
61. I. Rec, International Telecommunication Union, Geneva, 2006.
62. Veaux, et al., Superseded-cstr vctk corpus: English multi-speaker corpus for cstr voice cloning toolkit, 2016.
63. Tokuda et al., Speech Signal Processing Toolkit (SPTK) version 3.11. Available: sp-tk.sourceforge.net, 2017.
64. Morise et al., IEICE Transactions on Information and Systems, vol. 99, no. 7, pp. 1877-1884, 2016.
65. M. Morise, Interspeech, 2017, pp. 2321-2325, 2017.
66. Jia et al., Advances in Neural Information Processing Systems, pp. 4485-4495, 2018.
67. M. He et al., Robust sequence-to-sequence acoustic modeling with stepwise monotonic attention for neural TTS, arXiv preprint arXiv:1906.00672, 2019.
68. D. P. Kingma and J. Ba, Adam: A method for stochastic optimization, arXiv preprint arXiv:1412.6980, 2014.
69. A. Krogh and J. A. Hertz, Advances in Neural Information Processing Systems, pp. 950-957, 1992.
70. Kanai et al. Advances in Neural Information Processing Systems, pp. 435-444, 2017.
71. Srivastava et al. The Journal of Machine Learning Research, vol. 15, no. 1, pp. 1929-1958, 2014.
72. Ioffe and C. Szegedy, International Conference on Machine Learning, pp. 448-456, 2015.
73. Ba et al., Layer normalization, arXiv preprint arXiv:1607.06450, 2016.

What is claimed is:

1. A foreign accent conversion system, comprising:
in a computer system with at least one processor, at least one memory in communication with the processor and at least one network connection:
a plurality of models in communication with a plurality of algorithms configured to train said plurality of models to transform directly utterances of a non-native (L2) speaker to match an utterance of a native (L1) golden-speaker counterpart, said plurality of models and said plurality of algorithms tangibly stored in the at least one memory and in communication with the processor.

2. The foreign accent conversion system of claim 1, wherein the plurality of models are trained to:
create the golden-speaker using a set of utterances from a reference L1 speaker, which are discarded thereafter, and the L2 speaker learning the at least one language; and
convert the L2 speaker utterances to match the golden speaker utterances.

3. The foreign accent conversion system of claim 2, wherein the plurality of models are further trained to convert new utterances from the L2 speaker to match a new golden speaker utterances.

4. The foreign accent conversion system of claim 1, wherein the plurality of models comprises at least a speaker independent acoustic model, an L2 speaker speech synthesizer and a pronunciation correction model.

5. The foreign accent conversion system of claim 4, wherein the speaker independent acoustic model is trained to extract speech embeddings from the set of utterances.

6. The foreign accent conversion system of claim 4, wherein the L2 speaker speech synthesizer is trained to re-create the L2 speech from the speaker independent embeddings.

7. The foreign accent conversion system of claim 4, wherein the speaker independent acoustic model is trained to transform L1 speech into L1 speaker independent embeddings which are passed through the L2 speaker speech synthesizer to generate the golden speaker utterances.

8. The foreign accent conversion system of claim 4, wherein the pronunciation correction model is trained to convert the L2 speaker utterances to match the golden speaker utterances.

9. The foreign accent conversion system of claim 1, wherein the plurality of algorithms comprises a software toolkit.

10. A reference-free foreign accent conversion computer system, comprising:
at least one processor;
at least one memory in communication with the processor;
at least one network connection;
a plurality of trainable models in communication with the processor configured to convert input utterances from a non-native (L2) speaker learning one or more languages to native-like sounding output utterances of the one or more languages; and
a software toolkit comprising a library of algorithms tangibly stored in the at least one memory and in communication with the at least one processor and with the plurality of models which when said algorithms are executed by the processor train the plurality of models to convert the input L2 utterances.

11. The reference-free foreign accent conversion computer system of claim 10, wherein the plurality of models comprises at least a speaker independent acoustic model, an L2 speaker speech synthesizer and a pronunciation correction model.

12. The reference-free foreign accent conversion computer system of claim 11, wherein the speaker independent acoustic model is configured to extract speaker independent speech embeddings from a native (L1) speaker input utterance, from the L2 speaker or from a combination thereof.

13. The reference-free foreign accent conversion computer system of claim 11, wherein the L2 speaker speech synthesizer is configured to generate L1 speaker reference-based golden-speaker utterances.

14. The reference-free foreign accent conversion computer system of claim 10, wherein the pronunciation correction model is configured to generate L2 speaker reference-free golden speaker utterances.

15. A computer-implemented method for training a system for foreign accent conversion, comprising the steps of:
collecting an input set of input utterances from a reference native (L1) speaker and from a non-native (L2) learner;
training a foreign accent conversion model to transform the input utterances from the L1 speaker to have a voice identity of the L2 learner to generate L1 golden speaker utterances (L1-GS); and
training a pronunciation-correction model to transform utterances from the L2 learner to match the L1 golden speaker utterances (L1-GS) as output.

16. The computer-implemented method of claim 15, further comprising discarding the L1 input utterances after generating the L1 golden speaker utterances (L1-GS).

17. The computer-implemented method of claim 15, further comprising training the pronunciation-correction model to transform new L2 learner utterances (New L2) as input to new accent-free L2 learner golden speaker utterances (New L2-GS).

18. The computer-implemented method of claim 15, wherein the collecting step comprises extracting speaker independent speech embeddings from the input set of input utterances.

19. A method for transforming foreign utterances from a non-native (L2) speaker to native-like sounding utterances of a native (L1) speaker, comprising the steps of:
collecting a set of parallel utterances from the L2 speaker and from the L1 speaker;
building a speech synthesizer for the L2 speaker;
driving the speech synthesizer with a set of utterances from the L1 speaker to produce a set of golden-speaker utterances which synthesizes the L2 voice identity with the L1 speaker pronunciation patterns;
discarding the set of utterances from the L1 speaker; and
building a pronunciation-correction model configured to directly transform the utterances from the L2 speaker to match the set of golden-speaker utterances.

20. The method of claim 19, wherein the speech synthesizer comprises a speaker independent acoustic model configured to extract speaker independent speech embeddings from the parallel utterances.

21. The method of claim 19, wherein the pronunciation-correction model is further configured to directly transform new utterances from the L2 speaker to match a new set of golden speaker utterances.
